(19) United States
(12) Patent Application Publication
(10) Pub. No.: US 2018/0117705 A1
(43) Pub. Date: May 3, 2018

(54) DEVICE AND METHOD FOR LASER PROCESSING OF DIAMONDS

(71) Applicant: Menachem Margaliot, Bnei Brak (IL)

(72) Inventor: Menachem Margaliot, Bnei Brak (IL)

(21) Appl. No.: 15/802,478

(22) Filed: Nov. 3, 2017

Related U.S. Application Data
(60) Provisional application No. 62/416,824, filed on Nov. 3, 2016.

(51) Int. Cl. B23K 26/00; B23K 26/18; B28D 1/22

(52) U.S. Cl. CPC B23K 26/0006; B23K 26/0075; B28D 1/221; B23K 26/18

(57) ABSTRACT

A method is described or processing diamonds, either natural or artificially produced, by using a laser beam with minimal power output. The laser wavelength is fitted to the peak absorption wavelength of diamond, such as a helium-silver laser with a wavelength of 224 nm.

### FIELD OF THE INVENTION

The present invention relates generally to a method and device for cutting, shaping and polishing diamonds by a laser beam of wavelength identical to the peak absorption wavelength of diamond, or slightly shorter, with minimal damage to the specimen thus processed, due to the ability to use minimal laser power.

### BACKGROUND OF THE INVENTION

Laser processing of a large variety of materials is replacing conventional mechanical processes, due to the high accuracy, speed and flexibility provided by laser cutting, sawing and shaping and polishing machines.

Laser processing is based on the ability to focus the laser light beam to an extremely small focal spot, thus concentrating the beam energy to an extremely high power density, which can ablate very accurately a very small region of material, thus making it possible to produce very narrow and accurate cuts and slits in nearly every material.

This, however, is based on the existence of an interaction mechanism between the laser beam and the processed material. Thus, for example, if the material is totally transparent to the wavelength of the given laser, the beam will pass freely through the material, without transferring any energy to it. Accordingly, no ablation and hence no processing will take place.

Overcoming this difficulty necessitates intensifying the laser beam power density at the focal spot to the degree that the electric field at the focal spot is high enough (˜10⁹ V/m) to cause directly the disintegration of the atoms or molecules of the material—a process commonly referred to as “optical breakdown”.

However, using laser beams of extremely high power carries the risk of causing unwanted damage to the processed material. Depending on the nature of the material, this drawback may have significant negative consequences. In the case of diamond processing, the brittle nature of diamonds makes such an event rather likely (about 1% of laser processed diamonds crack in the present day laser sawing process). The present invention seeks to provide a solution to this problem by reducing drastically the power density needed for the process.

### SUMMARY OF THE INVENTION

The use of lasers for sawing and cutting diamonds is nowadays a common procedure. However, the need for high power and stability, has made the Nd:YAG laser, in its first (1064 nm) or second (532 nm) harmonics, the leading tool of trade.

The present invention presents a different and novel solution to the problem of very high laser beam power density, by using a wavelength or wavelengths at which the seemingly transparent material is opaque, namely the wavelength(s) at which the material absorbs light maximally, known as the absorption wavelength(s) of the material. In the case of diamond the prominent wavelength is 225 nm.

In an embodiment of the present invention, a laser emitting the above stated wavelength or slightly shorter is used to process diamonds, such as a helium-silver laser. The very strong absorption at this condition makes it possible to reduce significantly the laser power, thus reducing drastically the unintentional and unwanted damage to the processed material. The use of the helium-silver laser for diamond processing is heretofore unknown in the prior art.

### BRIEF DESCRIPTION OF THE DRAWINGS

The present invention will be understood and appreciated more fully from the following detailed description, taken in conjunction with the drawing in which:

FIG. 1 is a simplified illustration of a laser system for diamond processing, in accordance with a non-limiting embodiment of the invention.

### DETAILED DESCRIPTION OF EMBODIMENTS

Non-limiting features of the invention include:

Use of a laser beam of wavelength equivalent to the one of the absorption wavelengths of diamond, to saw, cut, shape and polish the processed specimen.

Use of a laser beam of wavelength shorter than above stated wavelength of the processed material, by as small an amount as available (such as but not limited to, 1% less, or alternatively 2% less, or alternatively 5% less, or alternatively 10% less), to saw, cut, shape and polish processed specimen.

Use of a laser beam of wavelength 224 nm, produced by a helium-silver laser to saw, cut, shape and polish diamonds, either natural or artificially produced, both gem stones and those used for in industrial processes.

Use of a laser beam of wavelength 224 nm, produced by a helium-silver laser operating at that wavelength to saw, cut, shape and polish diamonds, either natural or artificially produced, both gem stones and those used for in industrial processes

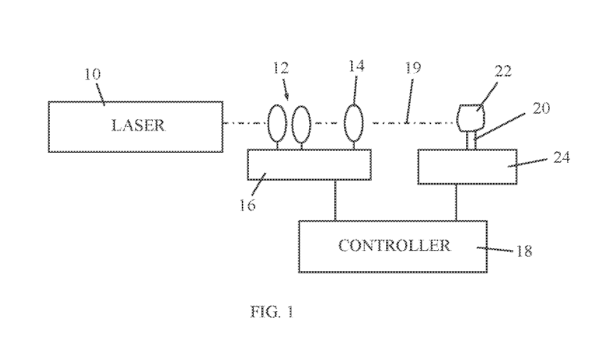

Reference is now made to FIG. 1, which illustrates a laser system for diamond processing, in accordance with a non-limiting embodiment of the invention.

The system may include, without limitation, a helium-silver ion laser 10, emitting a wavelength of 224 nm, an optical beam expander 12, including at least two lenses of a material highly transparent at the wavelength of 224 nm, and a beam modulator 14, such as a focusing lens or a lens combination, also transparent at the above wavelength, or a curved mirror, highly reflective at that wavelength.

The optical beam expander 12 and/or the beam modulator 14 may be mounted together or separately on a holder 16. The holder 16 may be adjustable, either manually or by a controller 18, in order to the place the optical components in the appropriate location along the optical path of the laser beam 19.

A gem holder 20 is provided for holding the diamond 22 being processed by the laser beam 19. A multi-dimensional translation and/or rotational platform 24 may be coupled to gem holder 20 to enable placement of the processed diamond 22 at the appropriate positions and angles for the desired shaping. Platform 24 may be in controlled by controller 18.

What is claimed is:

1. A method comprising:
using a laser beam of a wavelength equal, within ±10%, to one of absorption wavelengths of a diamond, to saw, cut, shape or polish said diamond.

2. The method according to claim 1, wherein the wavelength is less than one of said absorption wavelengths.

3. The method according to claim 1, wherein the laser beam is at a wavelength of 224 nm.

4. The method according to claim 1, wherein the laser beam is produced by a helium-silver laser.

5. A system for processing diamonds, comprising:
a helium-silver ion laser configured to emit a beam at a wavelength of 224 nm;
and a gem holder configured to hold a diamond in a path of said beam.
